(19) United States
(12) Patent Application Publication
(10) Pub. No.: US 2026/0357513 A1
(43) Pub. Date: Nov. 12, 2026

(54) ARRANGEMENT AND METHOD FOR CONTROLLING MAGNESIUM SULPHATE FEED

(71) Applicant: UPM-KYMMENE CORPORATION, Helsinki (FI)

(72) Inventors: Esa HASSINEN, Helsinki (FI); Tom HULTHOLM, Helsinki (FI)

(21) Appl. No.: 19/125,002

(22) PCT Filed: Oct. 27, 2023
(86) PCT No.: PCT/FI2023/050603

§ 371 Date: Apr. 28, 2025

(30) Foreign Application Priority Data
Nov. 2, 2022 (FI) 20225978

(51) Int. Cl. D21C 7/12; D21C 9/10

(52) U.S. Cl. CPC D21C 7/12; D21C 9/1052

(57) ABSTRACT

An arrangement (1) for controlling magnesium sulphate feed comprises a detector (2) arranged inside process flow after magnesium sulphate dissolution process and configured to measure a characteristic of the process flow by means of spectroscopy. The arrangement (1) further comprises a controller (3) connected to the detector (2) to receive measurement data from the detector (2) and configured to determine an amount of a substance in the process flow based on the measurement data and to control the feed of magnesium sulphate based on the determined amount of the one substance.

### BACKGROUND

The present disclosure relates to controlling magnesium sulphate feed in wood processing industry, and more particularly to an arrangement and method for controlling magnesium sulphate feed.

In oxygen delignification, the degradation of cellulose leads to yield losses and deterioration in the quality of the pulp. The degradation of cellulose is reflected in a decrease in the viscosity of the pulp. Cellulose degradation reactions are catalyzed by heavy metal residues in the pulp. Heavy metals are derived from wood and process water. Learning to control the metal profile of the pulp has been key to the development of oxygen delignification. However, the detrimental effect of heavy metals can be reduced by adding magnesium sulphate to the pulp, thus maintaining a higher yield and quality of the pulp.

In known solutions, preparation of magnesium sulphate water solution is typically fed at a predetermined ratio with respect to the dry cellulose, or samples are taken for laboratory analysis. The first option may be too uncertain for optimal results, especially due to wear of the equipment, whereas the latter is time consuming and the feedback loop is slow.

### BRIEF DESCRIPTION OF THE DISCLOSURE

An object of the present disclosure is to provide a new arrangement and method for controlling magnesium sulphate feed.

The object of the disclosure is achieved by a method and an arrangement which are characterized by what is stated in the independent claims. Some embodiments of the disclosure are disclosed in the dependent claims.

The disclosure is based on the idea of determining an amount of a substance in the process flow after magnesium sulphate dissolution process by means of spectroscopy and use it in pulping process. In other words, the measurement is made using spectroscopy and online from the process flow without a need for taking samples and taking samples to a laboratory for detailed analysis.

An advantage of the disclosure is that the measurements can be accurate and real time. The feedback time may be reduced considerably, and the process control improved.

### BRIEF DESCRIPTION OF THE DRAWINGS

In the following the disclosure will be described in greater detail by means of preferred embodiments with reference to the accompanying drawings, in which

FIG. 1 illustrates schematically some features related to a magnesium sulphate dissolution process according to an example;

FIG. 2 illustrates an arrangement for controlling magnesium sulphate feed; and

FIG. 3 illustrates a method for controlling magnesium sulphate feed.

### DETAILED DESCRIPTION OF THE DISCLOSURE

The disclosure relates to an arrangement and method for controlling magnesium sulphate feed.

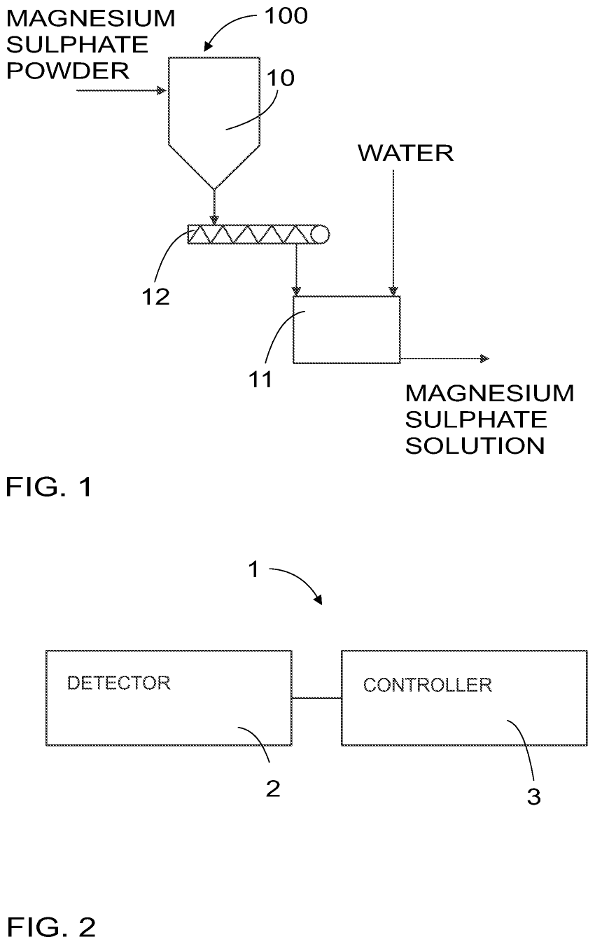

FIG. 1 illustrates schematically some features related to a magnesium sulphate dissolution process 100 according to an example. As mentioned in the background section, magnesium sulphate is used in many parts of pulping processes, especially in connection with delignification and bleaching processes.

Magnesium sulphate, such as hydrous magnesium sulphate or anhydrous magnesium sulphate, is typically delivered to a plant as a powder and dissolved in water, as shown in FIG. 1. Generally, the magnesium sulphate solution is added to a brown stock immediately after washing device or stage. The dosage amount may typically be in the range of 0.1 to 0.8 % by weight of magnesium sulphate per dry pulp, and the dosage consistency is about 25-150 g/l.

However, many factors affect optimal dosing process, and it might be beneficial to control the feed of magnesium sulphate, more particularly to control the feed of magnesium sulphate solution to the pulping process(es) and/or magnesium sulphate powder to the magnesium sulphate dissolution process. In this description, magnesium sulphate solution refers to a magnesium sulphate water solution, in other words magnesium sulphate dissolved in water. Firstly, in some embodiments it might be beneficial to adjust and/or control the dosage itself. For instance, it may be beneficial to optimize the dosage according to the local conditions of the process, such as the pulping process. By optimizing the dosage to the local conditions, a sufficient time can be ensured for the chemical to penetrate the pulp fibres before the pH is adjusted and the pulp is transported to an oxygen reactor. Under alkaline conditions, the magnesium component precipitates as active magnesium hydroxide (Mg(OH)₂), which can remove heavy metals by precipitation. In addition to or instead of these purposes, magnesium can also act as a radical scavenger. The magnesium component may also be able to protect the fibres through complex formation. As a result of such complex formation, cellulose fibres may be significantly less degraded. Thus, the use of magnesium sulphate may also maintain the viscosity of the pulp at a higher level than would be possible without the use of magnesium.

Secondly, some factors may affect optimal feed parameters in the magnesium dissolution process and should be taken into consideration as well. For instance, the magnesium sulphate powder may be fed, for instance via a feed silo 10, to a dissolution receptacle 11, such as a dissolution container, by a feed screw 12. Wear of such a feed screw might affect the actual amount of magnesium sulphate fed at a given feed rate. Thereby, according to an embodiment, feed of magnesium sulphate might be controlled by adjusting feed rate of magnesium sulphate and/or water to the dissolution receptacle, and/or by adjusting the dosing of the magnesium sulphate solution to the pulping process(es).

FIG. 2 illustrates an arrangement 1 for controlling magnesium sulphate feed.

An arrangement 1 for controlling magnesium sulphate feed, such as the arrangement of FIG. 2, comprises a detector 2 arranged inside process flow after magnesium sulphate dissolution process. This enables providing an inline measurement, in other words a measurement directly from the process flow by a detector 2 provided in the process flow, which is a real time measurement, as compared to samples taken to a laboratory for measurements. The detector 2 is configured to measure a characteristic of the process flow by means of spectroscopy.

The arrangement 1 for controlling magnesium sulphate feed, later called the arrangement 1, also comprises a controller 3. The controller 3 is connected to the detector 2 to receive measurement data from the detector 2. The controller 3 is configured to determine an amount of a substance in the process flow based on the measurement data, namely the measurement data received from the detector 2, and to control the feed of magnesium sulphate based on the determined amount of the substance.

According to an embodiment, the detector 2 may comprise an infrared spectrometer. More particularly, infrared spectrometer may be used to measure the concentration of compounds, for instance in one or more measurement points of the process, using infrared spectroscopy. According to an embodiment, the detector 2 more particularly may comprise a Fourier Transform Infrared (FTIR) Spectroscopy spectrometer. Fourier-transform infrared spectroscopy (FTIR) is a technique used to obtain an infrared spectrum of absorption or emission of a solid, liquid or gas. An advantage of such embodiments is that an FTIR spectrometer can simultaneously collect high-resolution spectral data over a wide spectral range. FTIR spectrometers are known as such and are, thus, not explained here in more detail.

Detectors 2 based on spectroscopy typically have a wavelength range, within which the detector 2 can be used and/or is configured to be used. In arrangements 1 and methods disclosed in this description, the detector 2 may be configured to use the whole wavelength range of the detector 2, when making the measurements disclosed in this description and accompanying claims and figures.

According to an embodiment, the detector 2 may be a spectrometer configured to use mid-infrared wavelength range in the measurement. According to an embodiment, the detector 2 may be a spectrometer configured to use a wavelength range of 400-4000 cm⁻¹. According to an embodiment, the detector 2 may be a spectrometer configured to use a wavelength range of 648-4000 cm⁻¹. According to an embodiment, the detector 2 may be a spectrometer configured to use a wavelength range of 800-1220 cm⁻¹, and according to a further embodiment, the detector 2 may be a spectrometer configured to use a wavelength range of 1000-1168 cm⁻¹. In some embodiments, it may be beneficial to use a wider range of wavelengths. This may be true for instance in embodiments, in which multiple characteristics of the process flow, for instance amount, such as concentrations, of multiple substances a measured. In some other embodiments, especially in embodiments, in which only one substance or only a few substances are measured, it may be beneficial to select a narrower range, within which the strongest correlation between the infrared spectroscopy measurements and amounts, such as the concentrations, of the substances of interest are found. For instance, in the embodiments of this disclosure, the strongest correlations for sulphate may be found within the wavelength range of 1000-1168 cm⁻¹, for example, whereby it may be beneficial to use this range or a range including this range.

According to an embodiment, the detector 2 may be arranged inside process flow after magnesium sulphate dissolution process by mounting the detector 2 to a line or a receptacle of the process flow by means of a mounting flange, directly to the line or receptacle and/or in another manner suitable for the type of the detector 2 in question. According to an embodiment, the detector 2 may be arranged in a line between a magnesium sulphate dissolution receptacle and a magnesium sulphate filtering receptacle. Such embodiments may be beneficial in applications, in which concentration of the magnesium sulphate to be fed to the pulping process is important and/or a quick feedback control is important. According to another embodiment, the detector 2 may be arranged in a line after the magnesium sulphate filtering receptacle and before dosing the magnesium sulphate to the pulping process, such as a delignification and/or bleaching process.

According to an embodiment, the detector 2 may be arranged inside process flow between magnesium sulphate dissolution process and dosing points of magnesium sulphate solution to pulping process. According to an embodiment, a dosing point may comprise a point at which magnesium sulphate is fed to at least one of a delignification process and a bleaching process. According to an embodiment, the bleaching process may comprise an oxygen based, hydrogen peroxide based, or chlorine dioxide based bleaching processes.

According to an embodiment, the amount of a substance in the process flow may comprise an amount of magnesium sulphate in the process flow material measured by means of spectroscopy.

According to an embodiment, the control of the feed of magnesium sulphate based on the determined amount of a substance may comprise adjusting, for instance controlled by the controller 3, the feeding rate of the feed screw 12 on the basis of magnesium sulphate solution concentration determined on the basis of measurement(s) made by means of spectroscopy. In other words, the feeding rate of the feed screw 12 may be adjusted based on a measured concentration of the magnesium sulphate solution. According to an embodiment, adjusting the feeding rate of the feed screw 12 may comprise adjusting, by the controller 3, rotational speed of the feed screw. The rotational speed of the feed screw 12 may be adjusted for instance by adjusting the speed of a motor driving the feed screw.

According to an embodiment, the control of the feed of magnesium sulphate based on the determined amount of a substance may comprise adjusting dosing of magnesium sulphate solution to pulping process at dosing points before at least one of a delignification process and a bleaching process on the basis of magnesium sulphate solution concentration determined on the basis of measurement(s) made by means of spectroscopy.

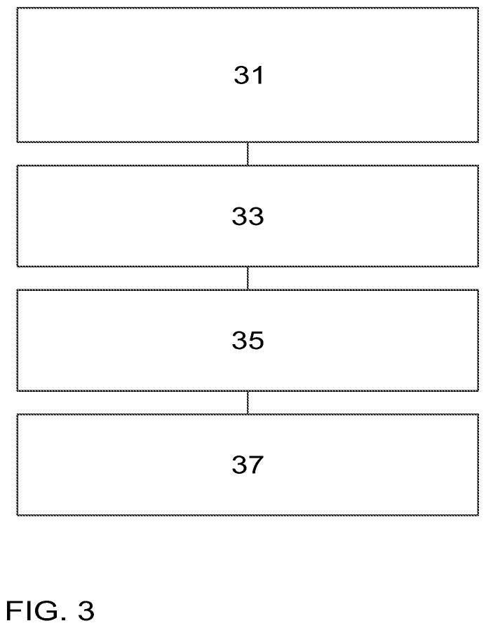

FIG. 3 illustrates a method for controlling magnesium sulphate feed.

According to an embodiment a method for controlling magnesium sulphate feed, such as the method of FIG. 3, may comprise the steps of measuring 31 by a detector 2 arranged inside process flow after magnesium sulphate dissolution process a characteristic of the process flow by means of spectroscopy; receiving 33 in a controller 3 connected to the detector 2 measurement data from the detector; determining 35 by the controller 3 an amount of a substance in the process flow based on the measurement data received from the detector; and controlling 37 the feed of magnesium sulphate based on the determined amount of a substance.

According to an embodiment, the controlling of the feed of magnesium sulphate based on the determined amount of a substance may comprise controlling feed rate of magnesium sulphate solution to cellulose pulp flow prior to at least one of a bleaching process and a delignification process on the basis of magnesium sulphate solution concentration determined on the basis of measurement(s) made by means of spectroscopy.

According to an embodiment, the method for controlling magnesium sulphate feed may be implemented by an arrangement 1 according to an embodiment or a combination of embodiments disclosed in this description, accompanying claims and/or figures, or a part of such an arrangement 1. According to an embodiment, the arrangement 1 may be configured to implement one or more steps of the method for controlling magnesium sulphate feed.

1. An arrangement for controlling magnesium sulphate feed comprising
a detector arranged inside process flow after magnesium sulphate dissolution process, and configured to measure a characteristic of the process flow by means of spectroscopy; and
a controller connected to the detector to receive measurement data from the detector and configured to determine an amount of a substance in the process flow based on the measurement data and to control the feed of magnesium sulphate based on the determined amount of the one substance.

2. The arrangement according to claim 1, wherein the detector comprises an infrared spectrometer.

3. The arrangement according to claim 2, wherein the detector comprises a Fourier Transform Infrared Spectroscopy spectrometer.

4. The arrangement according to claim 2, wherein the detector is a spectrometer configured to use mid-infrared wavelength range in the measurement.

5. The arrangement according to claim 4, wherein the detector is a spectrometer configured to use a wavelength range of 400-4000 cm⁻¹ or the detector is a spectrometer configured to use a wavelength range of 648-4000 cm⁻¹.

6. (canceled)

7. The arrangement according to claim 6, wherein the detector is a spectrometer configured to use a wavelength range of 800-1220 cm⁻¹ or the detector is a spectrometer configured to use a wavelength range of 1000-1168 cm⁻¹.

8. (canceled)

9. The arrangement according to claim 1, wherein the detector is arranged inside process flow after magnesium sulphate dissolution process by mounting the detector to a line or a receptacle of the process flow by means of a mounting flange or directly to the line or receptacle.

10. The arrangement according to claim 9, wherein the detector is arranged in a line between a magnesium sulphate dissolution receptacle and a magnesium sulphate filtering receptacle.

11. The arrangement according to claim 1, wherein the detector is arranged inside process flow between magnesium sulphate dissolution process and dosing points of magnesium sulphate solution to pulping process.

12. The arrangement according to claim 1, wherein the amount of a substance in the process flow comprises an amount of magnesium sulphate in the process flow material measured by means of spectroscopy.

13. The arrangement according to claim 1, wherein the control of the feed of magnesium sulphate based on the determined amount of a substance comprises adjusting the feeding rate of the feed screw on the basis of magnesium sulphate solution concentration determined on the basis of measurement(s) made by means of spectroscopy.

14. The arrangement according to claim 1, wherein the control of the feed of magnesium sulphate based on the determined amount of a substance comprises adjusting dosing of magnesium sulphate solution to pulping process at dosing points before at least one of delignification process and a bleaching process on the basis of magnesium sulphate solution concentration determined on the basis of measurement(s) made by means of spectroscopy.

15. A method for controlling magnesium sulphate feed, the method comprising:
measuring by a detector arranged inside a process flow after magnesium sulphate dissolution process a characteristic of the process flow by means of spectroscopy;
receiving in a controller connected to the detector measurement data from the detector;
determining by the controller an amount of a substance in the process flow based on the measurement data received from the detector; and
controlling the feed of magnesium sulphate based on the determined amount of a substance.

16. The method according to claim 15, wherein the detector is a spectrometer configured to use mid-infrared wavelength range in the measurement.

17. The method according to claim 16, wherein the detector is a spectrometer configured to use a wavelength range of 400-4000 cm⁻¹ or the detector is a spectrometer configured to use a wavelength range of 640-4000 cm⁻¹.

18. (canceled)

19. The method according to claim 18, wherein the detector is a spectrometer configured to use a wavelength range of 800-1220 cm⁻¹ or the detector is a spectrometer configured to use a wavelength range of 1000-1168 cm⁻¹.

20. (canceled)

21. The method according to claim 15, wherein the detector is arranged inside process flow after magnesium sulphate dissolution process by mounting the detector to a line or a receptacle of the process flow.

22. The method according to claim 15, wherein the amount of a substance in the process flow comprises an amount of magnesium sulphate in the process flow material measured by means of spectroscopy.

23. The method according to claim 15,
wherein the controlling of the feed of magnesium sulphate based on the determined amount of a substance comprises
controlling feed rate of magnesium sulphate solution to cellulose pulp flow prior to at least one of a bleaching process and a delignification process on the basis of magnesium sulphate solution concentration determined on the basis of measurement(s) made by means of spectroscopy.

24. The method according to claim 15,
wherein the controlling of the feed of magnesium sulphate based on the determined amount of a substance comprises
adjusting the feeding rate of the feed screw on the basis of magnesium sulphate solution concentration determined on the basis of measurement(s) made by means of spectroscopy.
